(19) United States
(12) Patent Application Publication
(10) Pub. No.: US 2019/0152753 A1
(43) Pub. Date: May 23, 2019

(54) SYSTEM FOR ASSISTING IN THE EVALUATION AND MANAGEMENT OF A DANGER ON AN AERIAL LIFT

(71) Applicant: HAULOTTE GROUP, L'HORME (FR)

(72) Inventors: Cyrille VIAL, Ecotay l'Olme (FR); Philippe LUMINET, LYON (FR)

(21) Appl. No.: 16/301,777

(22) PCT Filed: May 17, 2017
(86) PCT No.: PCT/EP2017/061837

§ 371 Date: Nov. 15, 2018

(30) Foreign Application Priority Data
May 18, 2016 (FR) 1654415

(51) Int. Cl. B66F 17/00

(52) U.S. Cl. CPC B66F 17/006; B66F 11/046

(57) ABSTRACT

Disclosed is a system for assisting in the evaluation and management of a danger on an aerial lift including a bottom portion provided with ground connecting members, a platform, and a lifting structure between the bottom portion and the platform, includes a device for capturing images of the platform. This system includes a device for displaying the images of the platform taken by the image capture device, provided next to a control console equipping the bottom portion of the aerial lift.

The invention relates to a system for assisting in the evaluation and management of a danger on an aerial lift.

Aerial lifts generally comprise a bottom portion provided with ground connecting members, a platform that rises to a height and on which operators are positioned to perform certain work, and a lifting structure between the bottom portion and the platform. Some aerial lifts are suitable, due to the deployment possibilities of their lifting structure, for performing work at substantial heights and with the platform offset relative to the bottom portion, which may cause, for example when the platform is located above the roof of a building, the platform and its occupants not to be visible by the personnel on the ground around the bottom portion. In case of an emergency regarding the platform's operators, the distance and the lack of visibility of the operators causes the latter to run the risk of not being able to signal the emergency situations.

It is known, in particular from WO-A-2012/109444 or US-A-2016/075543, to equip the platform with cameras and image processing means making it possible to detect potential emergency or dangerous situations, and to send an alert to a remote server or to block or trigger certain movements of the aerial lift. However, such devices do not allow the operators present on the platform to be rescued quickly by the people located on the ground, who may not suspect the emergency occurring on the platform.

The invention more particularly aims to resolve these drawbacks by proposing a new system for assisting in the evaluation and management of a danger, making it possible to react quickly to an emergency occurring on the platform of the aerial lift.

To that end, the invention relates to a system for assisting in the evaluation and management of a danger on an aerial lift including a bottom portion provided with ground connecting members, a platform, and a lifting structure between the bottom portion and the platform, this system including a device for capturing images of the platform.

According to the invention, the system includes a device for viewing images of the platform taken by the image capture device, provided near the control console equipping the bottom portion of the aerial lift.

Owing to the invention, the people located on the ground near the bottom portion of the aerial lift can view the images captured on the platform, which makes it possible to evaluate a potential emergency or dangerous situation regarding the operators and to trigger an appropriate procedure if necessary.

According to advantageous but optional aspects of the invention, such a system may incorporate one or more of the following features, considered in any technically allowable combination:
The control console of the aerial lift provided on the bottom portion is configured to allow the movement of the platform using images able to be viewed on the viewing device.
The system includes means, provided in the platform, for triggering a call signal intended for people located in the environment of the bottom portion.
The triggering of the call signal activates the broadcasting of the images of the platform taken by the viewing device.
The call signal includes audio and/or visual indications urging the people located in the environment of the bottom portion to view the images broadcast on the viewing device.
The call signal can be activated by a person present on the platform and/or by the triggering of a safety device of the aerial lift and/or by triggering a safety device of personal protective equipment of a person present on the platform.
The system includes a two-way audio communication device between the platform and the bottom portion.
The image capture device of the platform includes at least one video camera.
The image capture device includes two cameras arranged on either side of a portion of the lifting structure.
The operation of the viewing device is suitable for being triggered using a button of the control console located on the bottom portion.
The system includes means for detecting obstacles in the environment of the platform.
The system is configured for operating independently of a control system of the aerial lift.
The system includes means for emitting alert signals and sending images to a remote electronic device.
The system includes a device for viewing images taken by the capture device, provided on a control console of the platform.

The invention will be better understood, and other advantages thereof will appear more clearly, in light of the following description of a system for assisting in the evaluation and management of a danger according to its principle, provided as a non-limiting example and in reference to the appended drawings, in which:

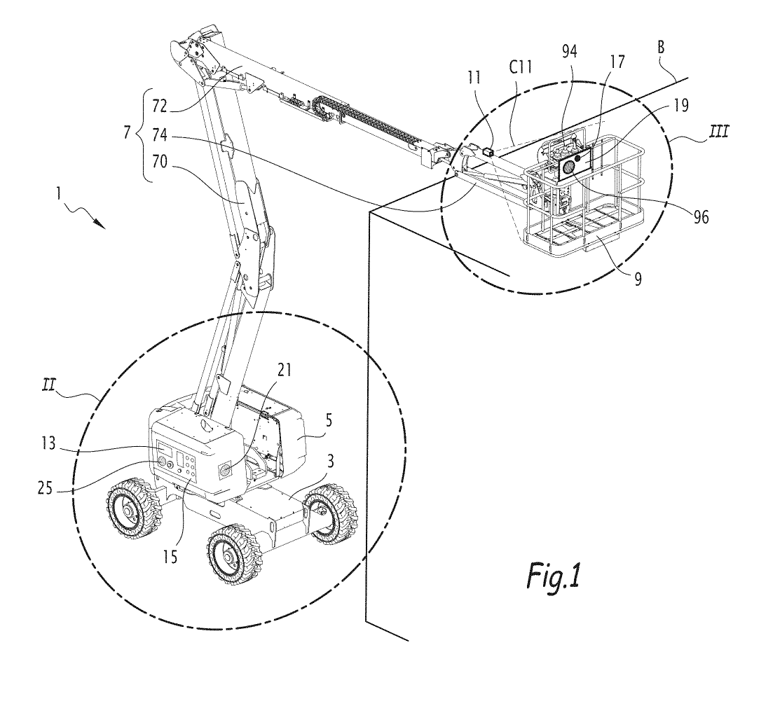

FIG. 1 is a perspective view of an aerial lift, the lifting structure of which is partially deployed, and the platform of which is overhanging the roof of a building, provided with a system for the evaluation and management of a danger according to the invention;

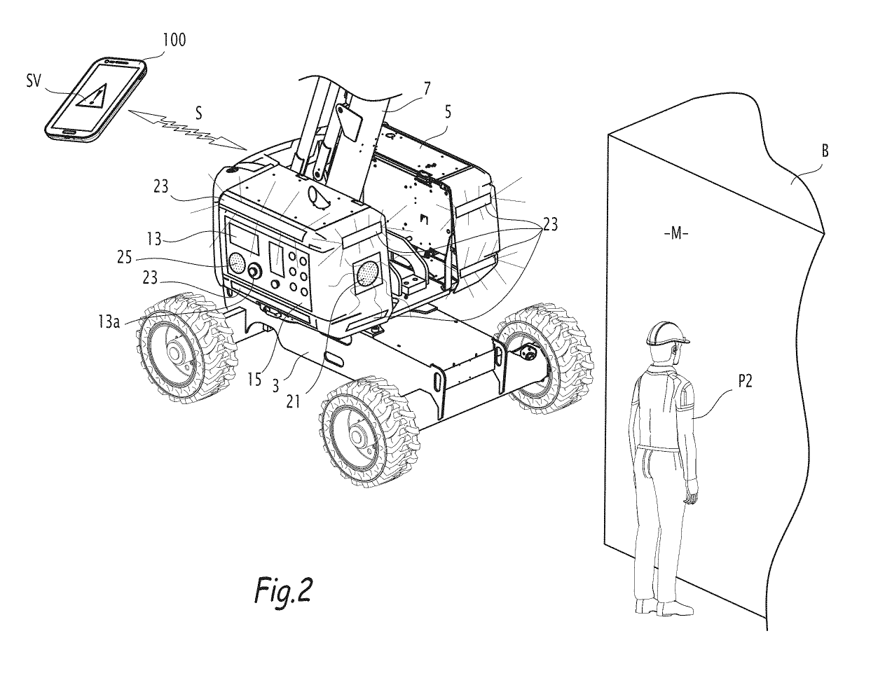

FIG. 2 is an enlarged view of detail II in FIG. 1;

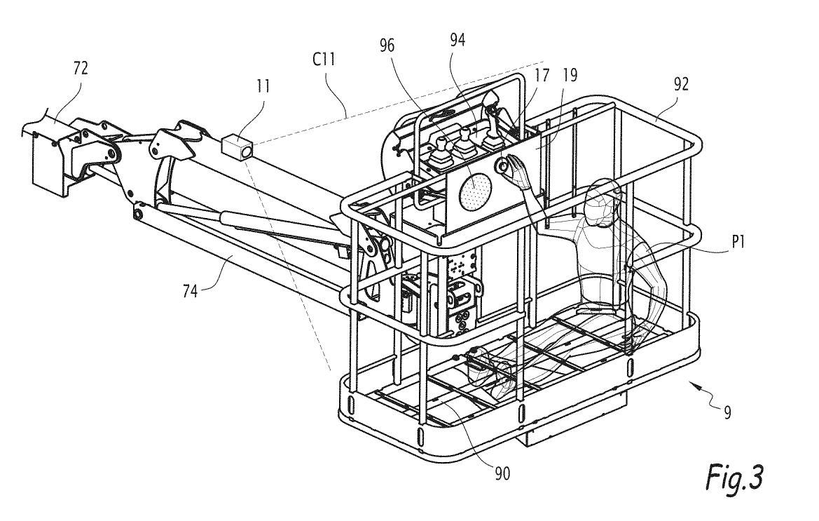

FIG. 3 is an enlarged view of detail III in FIG. 1;

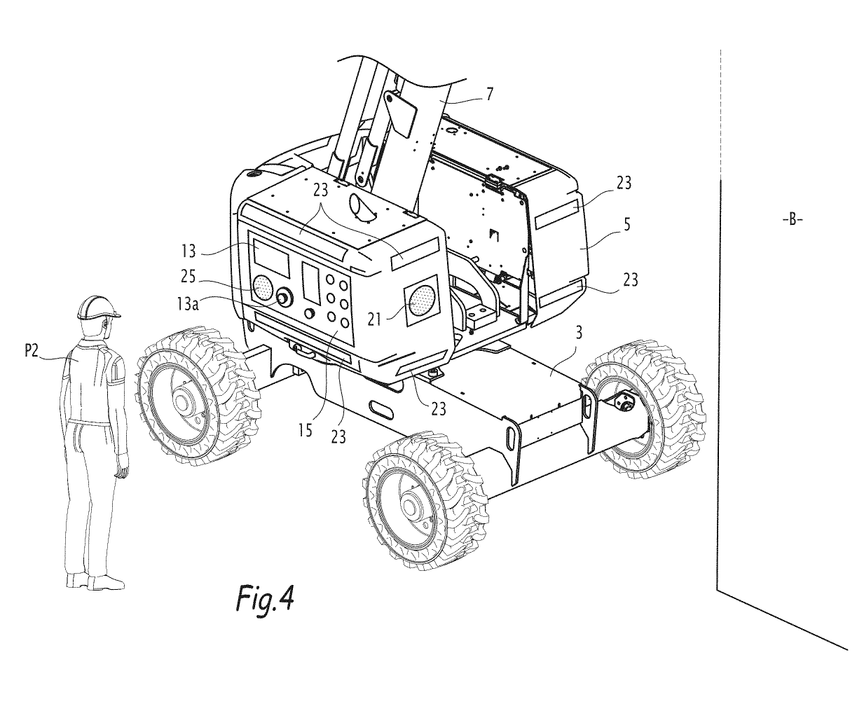

FIG. 4 is a view similar to FIG. 2, corresponding to a usage situation of the system of FIG. 1;

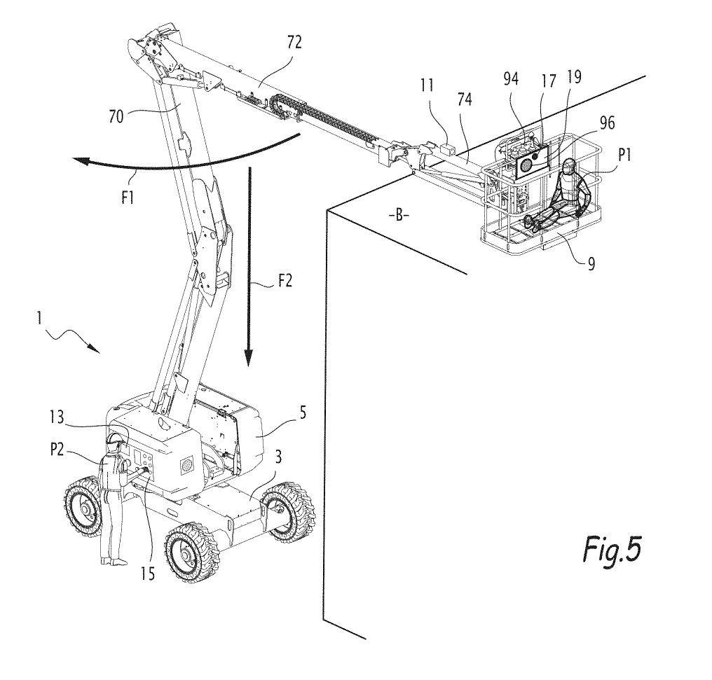

FIG. 5 is a view similar to FIG. 1, in an intervention situation implemented using the system of FIG. 1;

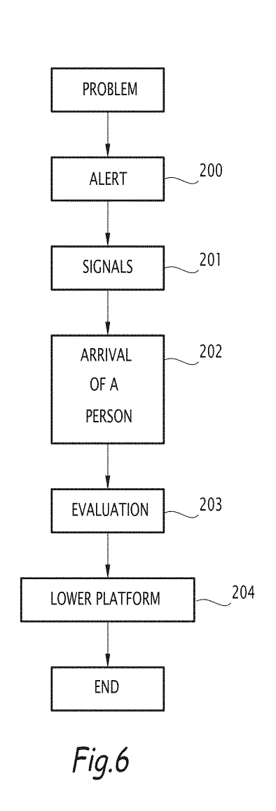

FIG. 6 is a logic diagram of an intervention procedure implemented using the system of FIG. 1;

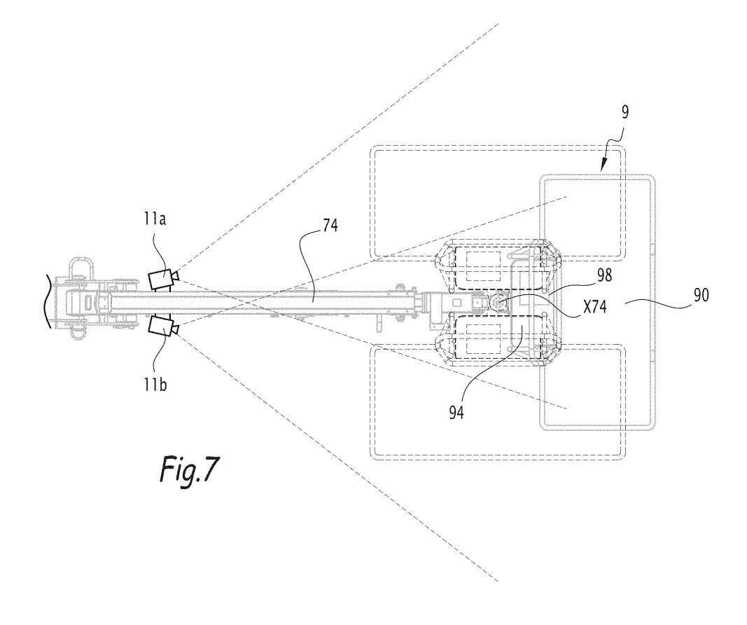

FIG. 7 is a top view of the platform and part of the lifting structure of the aerial lift of FIG. 1.

FIG. 1 shows an aerial lift 1 including a bottom portion having a chassis 3 equipped with ground connecting members, such as wheels or tracks. The bottom portion also includes a turret 5 rotatable relative to the chassis 3 along an axis perpendicular to the rotation axes of the wheels, a lifting structure 7 and a platform 9 supported by the lifting structure 7. The platform 9 includes a wire floor 90 surrounded by a guardrail 92.

The platform 9 is equipped with a control console 94 allowing a person present on the platform 9 to control the aerial lift 1, in particular the movements of the platform 9 relative to the chassis 3. In a known manner, the control console 94 allows the total control of the aerial lift, including the movements of the chassis 3 relative to the ground, the starts/stops, etc.

In this example, the lifting structure 7 includes a deploying lower arm 70, a telescoping upper arm 72 and a pendular arm 74. The movements allowed by the arm 70, 72 and 74 are known in themselves and will not be described in further detail below.

In the deployment configuration of the lifting structure 7 shown in FIG. 1, the platform 9 is positioned relative to the bottom portion such that the platform 9 overhangs a building B near which the aerial lift 1 is parked. In this configuration, people located near the chassis 3 may not, from their position, see the platform 9 or the people positioned on it. Such a situation incurs the danger that, in case of physical problem or accident occurring on the platform 9, the people located below may not be aware, in particular if the work environment is noisy or if the people located on the platform 9 are unable to signal their situation.

To that end, the aerial lift 1 is provided with a system for assisting in the evaluation and management of a danger. This assistance system includes a device for capturing images of the platform 9, including at least one video camera 11. The video camera 11 may for example be fastened on an element of the pendular arm 74 and cover a capture field C11 encompassing the platform 9 and a portion of its environment. To that end, the video camera 11 is equipped with a wide-angle or fisheye lens. The images taken by the video camera 11 may be outside the visible spectrum and suitable for recording under low lighting conditions, for example infrared images.

According to the invention, the assistance system also includes a device 13 for viewing images of the platform 9 taken by the image capture device. This viewing device 13 is provided on the bottom portion of the aerial lift 1. For example, the device 13 is made up of at least one screen provided on a side portion of the turret 5. This allows a person P2 present in the environment of the bottom portion to view what is occurring on the platform 9, evaluate whether the people present on the platform 9 are in a dangerous situation, and raise an alert, or act himself.

Advantageously, the viewing device 13 is provided near a control console 15 of the aerial lift 1, which equips the bottom portion and is configured to allow the movement of the platform 9 using images able to be viewed on the viewing device 13. The term “near” means that the viewing device 13 is placed close enough to the control console 15 to allow the controls to be manipulated by consulting the screen of the viewing device 13. In the illustrated example, the viewing device 13 is encompassed in the control console 15 and is placed alongside the controls. In an alternative that is not shown, the viewing device 13 may not be part of the control console 15 and may be installed in the form of a separate panel. The control console 15 is preferably provided on the turret 5 and allows an operator present on the ground to take control of control members of the aerial lift 1, and for example to perform movements of the lifting structure 7 making it possible to lower the platform 9 again and to help a person on the platform who is in difficulty. The operator on the ground may distinguish, on the viewing device 13, potential obstacles in the environment of the platform 9 and thus select the appropriate control members of the control console 15 to avoid these obstacles during maneuvers.

The assistance system advantageously includes means, provided in the platform 9, for triggering a call signal intended for one or several people P2 located in the environment of the bottom portion. As shown in FIG. 3, this triggering means may include a button 17 making it possible to trigger the call signal. This button 17 is advantageously on a panel 19 provided near the control console 94, and able to be actuated manually by a person P1 in difficulty who may in particular be lying down or seated on the floor 90.

The call signal is intended for people P2 who may perform a task around the aerial lift 1 on the ground, for example who may intervene near a wall M of the building B. The call signal may for example include a high-intensity alarm of the buzzer type and be accompanied by audio and/or visual indications, encouraging the person P2 to approach the aerial lift 1 and view the images broadcast on the viewing device 13. The triggering of the call signal activates the broadcasting of the images of the platform 9 taken by the viewing device 13. The audio and/or visual indications may include an alarm emitted by a speaker 21 provided on the turret 5, and lighted devices 23 also provided on the turret 5, and emitting flashes of light that may also blink. These lighted devices 23 may advantageously include directional elements such as arrows urging the person P2 to move toward the screen of the viewing device 13. The audio indications may in particular include prerecorded voice messages broadcast by the speaker 21, for example “Platform incident. Alert emergency services or press the button to communicate with the platform.”

Alternatively, the speaker 21 may be provided on the control console 15.

The call signal may also be activated from an anti-crushing device, not shown, provided on the platform 9 and suitable for being triggered if the person P1 present on the platform 9 is crushed by an object or an obstacle coming from above and pushed against the control console 94. The call signal may also be triggered by any other safety device of the aerial lift 1. The call signal may also be triggered by a safety device of personal protective equipment of people present on the platform, as described by FR 2,984,294. The safety device may for example be an alert device fastened on a closing element, such as a harness. Such an alert device may also be suitable for triggering the emergency stop of the aerial lift.

The assistance system also includes a two-way audio communication device between the platform 9 and the bottom portion of the aerial lift 1. This device allows direct voice communication between the people P1 and P2. This communication device includes an element 96 provided on the panel 19, and an element 25 provided close to the viewing device 13. The elements 96 and 25 include microphones and speakers. The viewing device 13 may include an activation button 13a able to be actuated by the person P2 and making it possible to initiate the viewing of images of the platform 9 and the communication with the person P1 present on the platform 9. In addition to the voice communication, prerecorded voice messages may also be sent by the person P1 via the element 96.

The activation button 13a is also useful in the absence of an emergency situation so that the person P2 can use the viewing device 13 to help maneuver the platform 9 while avoiding the obstacles he cannot see clearly directly from the ground.

Advantageously, the viewing device 13 is a screen that displays technical information, such as the fuel level or the number of hours of use of the machine, when the call signal and the activation button 13a are not used, i.e., when the image capture device is not operating.

Advantageously, the assistance system also includes means for detecting obstacles in the environment of the platform 9. These detection means comprise means for processing images captured by the camera 11 making it possible to identify potential obstacles in the environment of the platform 9. For example, these obstacles are shown on the viewing device 13 by a bright color. Optionally, the obstacles may also be detected by proximity sensors, and signaled by visual signals displayed on the periphery of a virtual depiction of the platform 9.

The assistance system is configured to operate independently of a system, not shown, for controlling the aerial lift 1, also called “control-command” system, which encompasses sensors, processors and software processing all of the operating data of the aerial lift 1 for controlling the movement means of the lifting structure 7 and the aerial lift 1 relative to the ground. Thus, even if the control system is deactivated, for example if an emergency stop button is pushed in on the control console 94 or if the control system is faulty, a potential dangerous situation on the platform 9 will nevertheless be signaled and will make it possible to implement an appropriate procedure.

The assistance system advantageously includes means for emitting alert signals and sending images to a remote electronic device. For example, the call signals may be accompanied by the emission of a signal S, sent by wireless technology, for example to a mobile telephone 100 belonging to a manager of the worksite on which the aerial lift 1 moves. The signal S will cause a visual signal SV to appear on the mobile telephone 100 of the worksite manager, making it possible to signal the ongoing dangerous situation on the platform 9, as well as an audio signal. The broadcasting of the images taken on the platform 9 of the mobile telephone 100 will allow the person receiving this call signal to become aware of the situation and carry out the appropriate procedures.

The assistance system makes it possible to implement a rescue procedure shown in FIGS. 5 and 6. If a person present on the platform 9 has a problem, this person triggers the alert, in a step 200, using the button 17.

In a step 201, the triggering of the alert causes the emission of visual and audio signals using the speaker 21 and lighted indicators 23. The signal S is also sent to the mobile telephone 100, or to any other device. The images of the camera 11 are sent to the viewing device 13, and the audio communication between the platform 9 and the bottom portion is activated.

In a step 202, a person P2 alerted by the signals arrives near the viewing device 13 to provide assistance and signals his presence by activating the button 13a and communicates with the person P1. At this moment, the visual and audio alert signals provided on the turret 5 are stopped.

In a step 203, the person P2 dialogues with the person P1 and evaluates the situation with the available images.

In a step 204, if the situation requires it and if the person P2 is capable of doing so, the person P2 takes control of the aerial lift 1 using the control console 15 and initiates the lowering of the platform 9 with the person P1 who is present thereon, as shown by the arrows F1 and F2 in FIG. 5. Once the platform 9 has been lowered close to the ground, the procedure ends in the person P1 can next the cared for by the outside emergency services.

The activation of the alarm signals, viewing of the images and audio communication may also trigger the emission of audio instructions intended for people P2 present on the ground, who are not necessarily familiar with the operation of the aerial lift 1, to provide them with the necessary information to carry out the rescue procedure when they arrive near the viewing device 13 and the control console 15.

The control console 15 preferably has a screen and indicators making it possible to view operating parameters and authorized movements of the aerial lift 1, calculated by the control system. If the aerial lift 1 is in an unstable situation due to the position of the platform 9 relative to the bottom portion, movement prohibitions may be displayed on the control console 15, urging the person in front of it not to maneuver the aerial lift 1 and to wait for the rescue services to arrive. The assistance system may also include audio and/or visual means urging a person present in the environment of the chassis 3 and the turret 5 to move away from the aerial lift 1, in particular if a maneuver has caused the platform 9 to come into contact with electrical systems, causing electrification of the person P1 and potential danger for the people P2 approaching the bottom portion.

A second embodiment of the invention is shown in FIG. 7. In this embodiment, traditionally, the platform 9 is rotatable relative to the pendular arm 74, along an axis X74 perpendicular to the floor 90 of the platform 9. As a result, when the platform 9 pivots relative to the pendular arm 74 along the axis X74, part of the platform 9 can be hidden from the field of the camera 11. In the embodiment of FIG. 7, the image capture device therefore includes two cameras 11a and 11b arranged on either side of the pendular arm 74 so as to be able to view the platform 9 on each side of the pendular arm 74 and to be able to completely view the platform 9 if the latter is completely pivoted toward one side of the pendular arm 74, as shown by the positions of the platform 9 in dotted lines. If the image capture device includes two cameras 11a and 11b, the viewing device 13 is suitable for selectively displaying the images captured by the camera 11a or 11b depending on the orientation of the platform 9, or simultaneously displaying the juxtaposed images from the cameras 11a and 11b.

According to one embodiment of the invention that is not shown, the assistance system may include image capture devices other than video cameras. These may for example be thermal imaging cameras.

According to another embodiment that is not shown, the assistance system may incorporate processing means allowing facial recognition to identify the people present on the platform 9 and display this information on the viewing device 13 and/or on the visual signal SV of the mobile telephone 100.

According to another embodiment that is not shown, the control console 15 provided on the turret 5 may be movable around the turret 5 so as to make it easier for the people on the ground to access. The control console 15 communicates with the lift 1 via a wired or wireless connection.

According to one embodiment of the invention that is not shown, the image capture device may not be secured to the aerial lift 1 and may for example be fastened on a structure placed on the worksite.

According to another embodiment shown in FIG. 7, but which may be combined with the other embodiments, the control console 94 may also include a device 98 for viewing images taken by the capture device 11. Thus, the images allow an operator controlling the aerial lift 1 from the platform 9 to monitor viewing angles that may potentially be hidden, in particular behind the operator. Thus, the operator may use the video images like a rear-view mirror, which prevents him from having to turn around during maneuvering to watch for obstacles.

The invention is not limited to an aerial lift with a turret and an articulated arm as shown in this example, and is also applicable to all types of aerial lifts for personnel, in particular lift structures of the type with a telescoping arm, scissor and vertical mast and lifts mounted on a truck chassis, a trailer chassis and an industrial truck.

The technical features of the embodiments and alternatives described above may be combined with one another to form new embodiments of the invention.

1-15. (canceled)

16. A system for assisting in the evaluation and management of a danger on an aerial lift including a bottom portion provided with ground connecting members, a platform equipped with a control console enabling control of the aerial lift, and a lifting structure between the bottom portion and the platform, said system including a device for capturing images of the platform,
the system comprising a device for viewing images of the platform taken by the image capture device, provided near the control console equipping the bottom portion of the aerial lift, the viewing device and the control console equipping the bottom portion being provided on an outer portion of the bottom portion accessible to an operator on the ground.

17. The system according to claim 16, wherein the control console of the aerial lift provided on the bottom portion is configured to allow the movement of the platform using images able to be viewed on the viewing device.

18. The system according to claim 16, further comprising means, provided in the platform, for triggering a call signal intended for people located in the environment of the bottom portion.

19. The system according to claim 18, wherein the triggering of the call signal activates the broadcasting of the images of the platform taken by the viewing device.

20. The system according to claim 19, wherein the call signal includes audio and/or visual indications urging the people located in the environment of the bottom portion to view the images broadcast on the viewing device.

21. The system according to claim 18, wherein the call signal can be activated by a person present on the platform and/or by the triggering of a safety device of the aerial lift and/or by triggering a safety device of personal protective equipment of a person present on the platform.

22. The system according to claim 16, further comprising a two-way audio communication device between the platform and the bottom portion.

23. The system according to claim 16, wherein the image capture device of the platform includes at least one video camera.

24. The system according to claim 23, wherein the image capture device includes two cameras arranged on either side of a portion of the lifting structure.

25. The system according to claim 16, wherein the operation of the viewing device is suitable for being triggered using a button of the control console located on the bottom portion.

26. The system according to claim 16, further comprising means for detecting obstacles in the environment of the platform.

27. The system according to claim 16, further configured for operating independently of a control system of the aerial lift.

28. The system according to claim 16, further comprising means for emitting alert signals and sending images to a remote electronic device.

29. The system according to claim 16, further comprising a device for viewing images taken by the capture device, provided on a control console of the platform.

30. The system according to claim 16, wherein the viewing device and the control console equipping the bottom portion are provided on a side portion of a turret of the bottom portion.
